(19) United States
(12) Patent Application Publication
(10) Pub. No.: US 2009/0188079 A1
(43) Pub. Date: Jul. 30, 2009

(54) MECHANISM FOR OPENING AND CLOSING AN APPLIANCE

(75) Inventors: Lothar Fuhrmeister, Schalksmühle (DE); Henning Taschke, Bochum (DE)

Correspondence Address: K.F. ROSS P.C., 5683 RIVERDALE AVENUE, SUITE 203 BOX 900, BRONX, NY, 10471-0900, US

(73) Assignee: LUMBERG CONNECT GMBH, Schalksmuehle (DE)

(21) Appl. No.: 12/281,696

(22) PCT Filed: Aug. 27, 2007
(86) PCT No.: PCT/DE2007/001523

§ 371 Date: Sep. 4, 2008

(30) Foreign Application Priority Data
Sep. 5, 2006 (DE) 10 2006 042 077.2

(51) Int. Cl. E05D 11/00

(52) U.S. Cl. 16/297; 16/277; 16/304

(57) ABSTRACT

The invention relates to a mechanism (10) for opening and closing an appliance, said mechanism comprising at least one first (15) and a second (16) base part which are arranged so as to move relative to one another around a common axis of rotation (D, d) and can be put into a first and a second end position, where the path of motion of the base parts, which is situated between the two positions, is covered automatically by means of a spring tension which is exerted by a spring element (17) and which is initially set up manually, one end of the spring element being fixed on a first base part and the other end being fixed on a second base part. It is an object of the invention to provide a relatively simple and relatively small-construction mechanism for opening and closing an appliance. The object is achieved by a mechanism based on claim 1, which is characterized in that the spring element freely spans the space between the fixing points and thus dispenses with any intermediary components, such as guides for the spring element or control units.

The invention relates to a mechanism for opening and closing an appliance, such as a mobile telephone or personal digital assistant, that comprises at least one first and one second base part that are mounted so as to move about a common rotation axis relative to each other, and are able to be moved between first and second end positions, the movement path between the two positions of the base parts being traversed partially automatically by means of spring tension exerted by at least one spring and created at least partially manually, the spring being affixed at one end to the first base part and at the other end to the second base part.

Requirements in terms of the miniaturization of mobile communications devices, such as, for example, mobile telephones, minicomputers, and similar devices, combined with an increasing range of functionality have for some time now resulted in a type of appliance that has a housing that in the broadest sense of the term is divided. Whenever the appliance is not in use, both housing parts are located relative to each other in a manner that to the greatest extent saves space, in particular, folded down onto each other or slid one over the other.

For purposes of operation, the two housing parts are separated, i.e. unfolded or slid open, so as to make the control elements accessible and provide convenient operation. One example known from the heterogeneous prior art is EP 0 961 459 [U.S. Pat. No. 6,209,173], which has a folding mechanism.

In order to provide simpler manipulation of mobile appliances, the trend has been to move to an approach whereby one part of the opening and closing motion is caused to proceed automatically by means of springs. To this end, for example, EP 05 023 836 of applicant discloses a mechanism of the generic kind for opening and closing an appliance in which the housing parts are pivoted relative to each other, both housing parts being able to occupy first and second stable end positions relative to each other and a control mechanism composed of spring bars with a control element toggling the housing parts out of any intermediate position into one or the other relative end position.

To express it another way, what is required to open or close the appliance is to effect a manual pivot motion up to a force-reversal point from which the motion then proceeds automatically due to the created spring tension.

US 2004/0203523 A1 can also be viewed as prior art of the generic kind in which the pivot motion is effected from a first to a second stable end position as a result of a spring tension that was created manually, however, the opposite movement is effected automatically due to the spring tension applied. In the embodiment of a mobile telephone as illustrated, the spring tension is created during closing of the phone, whereas opening occurs automatically.

A particular disadvantageous aspect of the referenced prior art is the costly design of the mechanism revealed therein for opening and closing the appliance, in particular, the massive pivot joint composed of multiple parts and the space-occupying guide for the spring since this constructive design conflicts with the miniaturization requirements for mobile appliances.

While the pivot mechanism disclosed in EP 05 023 836 has been significantly simplified as compared with the above, even this mechanism must be viewed as capable of improvement in regard to its constructive size.

The object to be attained by the invention is therefore to create a mechanism for opening and closing an appliance that is simpler and of smaller construction in comparison with the prior art.

The object is attained by a mechanism as indicated in claim 1 that is characterized in that the spring freely spans the space between the anchor points, thereby eliminating the need for any intermediary components, such as, for example, guides or control elements. The control mechanism according to the invention is composed only of the absolutely required components, specifically two appliance parts, their common rotation axis, and one spring each mounted on the first and second appliance part.

In a preferred embodiment, the spring is prestressed at the end positions of the base parts and extending over the movement path of the same such that the spring tension required by the two appliance parts to move independently relative to each other does not need to be created solely by manual movement of both parts.

Another advantageous aspect is for one base part to have a cutout that a rotary stop of the other base part engages simply to limit the maximum travel of the base parts relative to each other, the rotary stop preferably being designed as a fastening means for the spring.

C-shaped springs, or springs that are designed as meander-type springs, can be easily fabricated in a cost-effective manner as a part stamped out of a metal or plastic sheet, and additionally have the advantage of an especially space-saving geometry. Use of these springs enables the mechanism to be designed very flat.

Having the rotation axis of the base parts located within a circular arc, the center of which is the anchor point for the spring on the base part and the radius of which runs through the anchor point of the spring on the second base part, in particular enables springs to be used that are under tensile load. In addition, the spring can be accommodated in a space-saving manner in the area of the rotation axis.

If the purpose is to use a spring that has a compressive load as the prestress, a possible approach involves a mechanism whose rotation axis is located outside the circular arc whose center is the anchor point for the spring on the first base part and whose radius runs through the anchor point of the spring on the second base part.

In one embodiment, provision is made whereby the movement path corresponds to a partial circular path and the manually effected motion of the base parts relative to each other increases the spring tension up to a force-reversal point, with the result that after traversing the force-reversal point the relative motion is completed automatically with release of the spring tension, the force-reversal point corresponds to the intersection of a straight line that runs through the anchor point of the spring on the first base part and the rotation axis, and corresponds to the partial circular path.

Provision is made here whereby the movement path corresponds to a partial circular path of approximately 90°, while the two end positions are each set at an angle of approximately 45° to a straight line that runs through the anchor point of the spring on the first base part and the rotation axis.

The two last-referenced embodiments thus form a mechanism having two stable end positions. However, in order for an independent motion of the parts to be effected, a force-reversal point must first be overcome; part of the motion must therefore be effected manually. In this embodiment, the spring tension thus forces the base parts out of any intermediate position into one of the stable end positions.

In another embodiment, provision is made whereby both end positions lie along the same straight line that runs through the anchor point of the spring on the first base part and the rotation axis, as a result of which the motion into the first end position is completed solely due to the spring tension, while the motion into the second end positions is effected manually.

It is advantageous in this regard if the two base parts are mechanically lockable to each other.

The two above-referenced embodiments therefore relate to an appliance in which only one end position—preferably the open position for the appliance—is stable, while the mechanism in the second end position—preferably the closed position of the appliance—is advantageously locked. What is achieved thereby is that releasing the lock results in the appliance opening automatically.

Finally, what is particularly advantageous is if the freely tensioned spring between the stop means is unguided so as to keep the size of the mechanism to a minimum.

Generally, the invention is explained most simply based on the following description of the drawing in which the invention is described by way of example using a schematically illustrated mobile telephone. In the drawing:

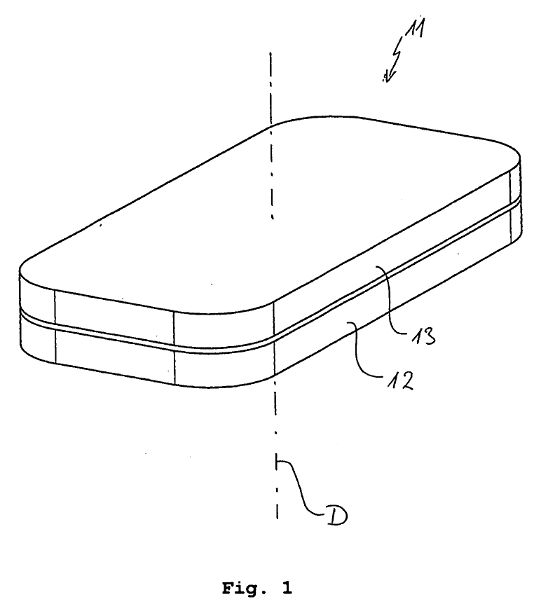

FIG. 1 shows a schematically illustrated mobile telephone with a closed housing;

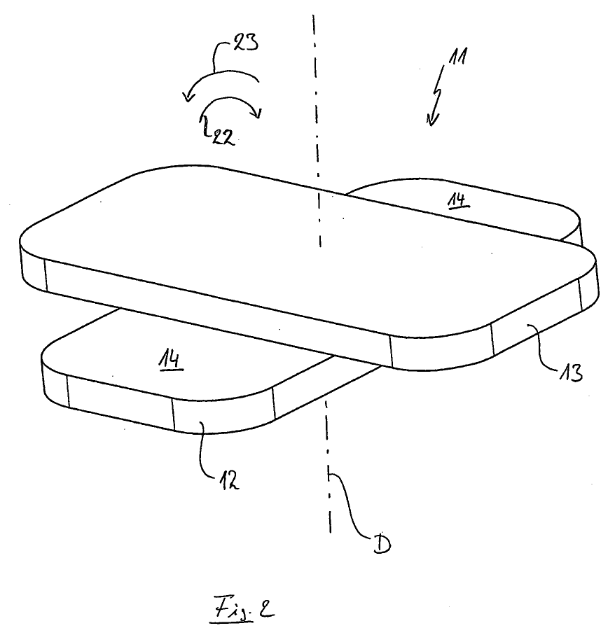

FIG. 2 shows the mobile telephone of FIG. 1 in the open position;

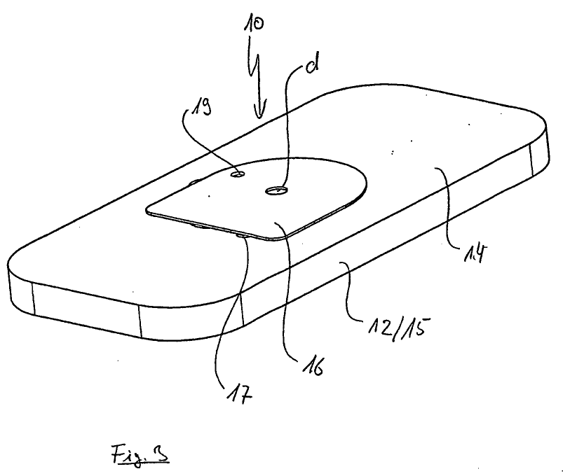

FIG. 3 is a view illustrating the bottom housing part of the mobile telephone with the mechanism according to the invention;

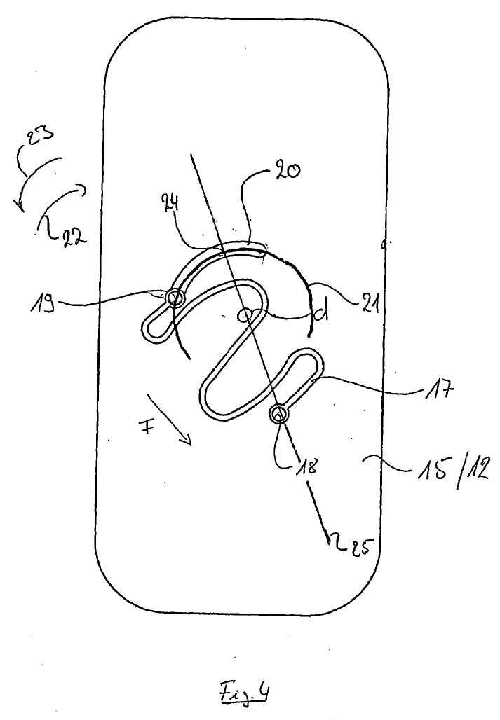

FIG. 4 is a view illustrating the spring of the mechanism according to the invention in FIG. 3 mounted in the bottom housing part;

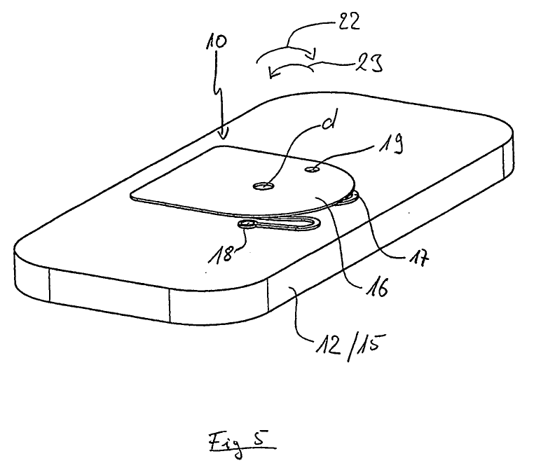

FIG. 5 is a view like FIG. 3 but in the open position;

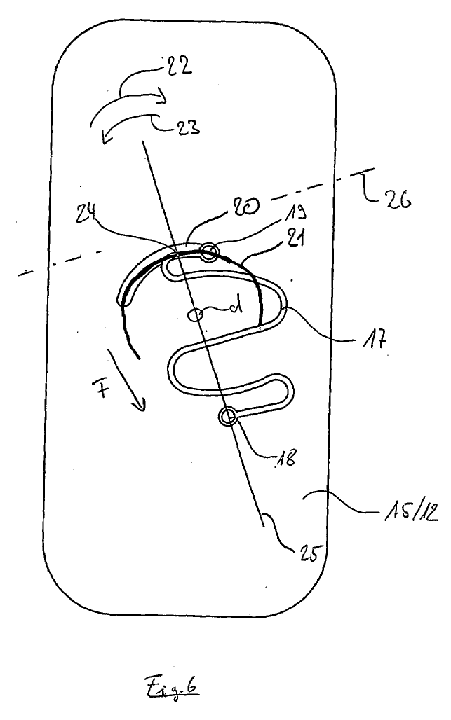

FIG. 6 is a view illustrating the spring of the mechanism according to the invention as shown in FIG. 5;

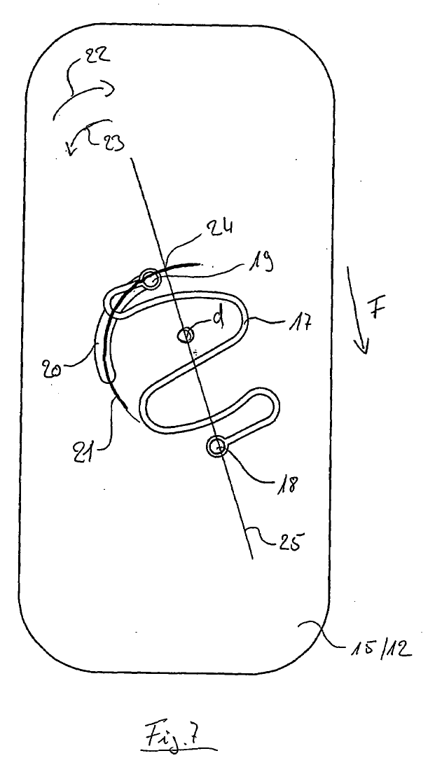

FIG. 7 is a view illustrating the bottom housing part of a mobile telephone and the spring of the mechanism according to the invention for opening or closing when in the closed position of an alternative embodiment; and

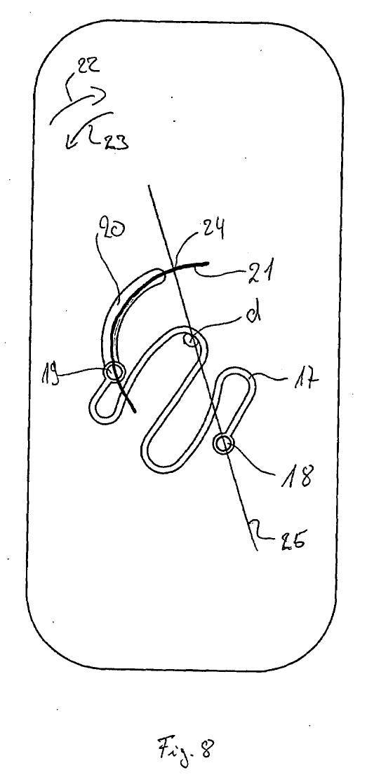

FIG. 8 is an illustration of the mechanism according to the invention of FIG. 7 when in the open position.

In the description of the drawing, the two embodiments of the invention are shown based on a schematically illustrated mobile telephone 11 comprising a housing 12 composed of a first (bottom) housing part 12 and a second (top) housing part 13. Hereafter bottom housing part 12 is identified as the bottom shell 12 and the top housing part 13 is identified as the top shell 13.

FIG. 1 shows the mobile telephone 11 in its closed position in which the housing parts 12 and 13, or bottom shell 12 and top shell 13, are arranged congruently one over the other.

In order to provide access to additional control elements (not shown) that are mounted on a surface 14 of the bottom shell 12 facing the top shell 13, both the housing parts 12 and 13 are pivotal relative to each other about a geometric rotation axis D.

In FIG. 2, the top shell 13 is shown as pivoted 90° about the central vertical rotation axis d of the two housing parts 12 and 13. With reference to the drawing plane, an upper section of the surface 14 facing the top shell 13 is thus accessible to the operator, thereby allowing additional control elements, such as, for example, a keyboard to be accommodated here.

FIG. 3 shows the mobile telephone 11 of the previous figures without the top shell 13 and provides a view of the mechanism according to the invention for opening and closing the mobile telephone 11 that is here in the closed position of FIG. 1.

A mechanism 10 is composed of a first base part 15 and a second base part 16. In this embodiment, first or bottom base part 15 corresponds to the bottom shell 12, whereas the second or top base part 16 is designed as a rotary plate, thus forming a separate intermediate component that is connected so the top shell 13. However, it is also conceivable to have top shell 13 itself function as top base part 16, or, on the other hand, to design the first base part 15 and the second base part 16 each as a separate rotary plate.

The bottom base part 15 and top base part 16 are connected to each other through the (physical) rotation axis d about which the top shell and bottom shell 13, 12 pivot relative to each other.

In FIG. 3, a spring 17 is shown only in outline and is anchored to the bottom base part 15 or bottom shell 12 at one end, and to the top base part 16 at the other end.

For purposes of understanding the following description of function, what must be kept in mind is that in all drawings the bottom shell 12 of the mobile telephone 11 remains unchanged in terms of its position in the drawing plane; in other words, only the top shell 13, not shown in FIGS. 3 through 8, or the top base part 16 is pivoted relative to the bottom shell 12.

FIGS. 4 through 6 relate to a first embodiment in which the top shell 13 has two stable end positions and is forced by the spring 17 out of each intermediate position into one or the other end position, in other words, into the open or closed position.

Starting with FIG. 3, in which the bottom shell and top shell 12 and 13, rest congruently one upon the other, FIG. 4 is a view of bottom shell 12 wherein second or top base part 16 shown in FIG. 3 is omitted.

The rotation axis d that functions to pivot both the housing parts 12 and 13 is also shown, as is the spring 17 mounted between both the housing parts 12 and 13.

The spring 17 is provided at one end with a first anchor point 18 on the bottom base part 15, and at the other end with a second anchor point 19 on the second base part 16 (not shown).

The anchor point can be fasteners or other means such as screws, pin-like stops, drill holes in the base parts 15 and 16 that hooks of spring 17 engage.

At reference 20, the base part 15 has a guide designed here in the form of a gate that the anchor point 19 designed as a pin-like stop 19 engages, thereby limiting the maximum travel for bottom shell 12 and top shell 13 relative to each other in the manner of a rotary stop. The anchor point 19 and guide 20 thereby interact to define the first and second stable end positions of housing parts 12 and 13, or the two end positions of the rotary motion.

The spring 17 designed as a meander-type spring in FIG. 4 is under prestress and, if the first anchor point 18 is defined as a fixed point, pulls the second anchor point 19 along a circular movement path 21 with rotation axis D as the center in spring-force direction F as far as the rotary stop allows.

Since the first anchor point 18 defined as a fixed point lies outside the center of the circular movement path 21, the distance between the anchor points 18 and 19 increases when the bottom shell 12 and top shell 13 are pivoted relative to each other in the direction of arrow 22, initially up to a maximum, the spring 17 being further tensioned.

A force-reversal point 24 lies at the site of maximum distance between the anchor points 18 and 19, this force-reversal point corresponding to an intersection of movement path 21 and a straight line 25 running through first anchor point 18 and geometric rotation axis D.

The relative travel of the housing parts 12 and 13 must be effected manually until force-reversal point 24 is reached; after traversing the force-reversal point 24 the movement is continued automatically due to tension of the spring 17.

FIG. 5 now provides a view of the bottom shell 12 or the mechanism 10 corresponding to FIG. 2, i.e. the top shell 13 and the second base part 16 connected to this shell have been pivoted 90° in the direction of the arrow 22. As a result, the mobile telephone 11 is in the open position as in FIG. 2.

FIG. 6 again provides a view of the bottom shell 12 shown in FIG. 5 or the mechanism 10 where the second base part 16 is omitted.

What is accordingly illustrated is the second stable end position in which both housing parts have been pivoted toward each other manually until reaching the force-reversal point 24, and due to spring tension F have independently traversed the remaining residual travel along the movement path 21 as limited by the rotary stop, as is shown by the changed position of the anchor point 19 as compared with FIG. 4.

It is obvious that the above descriptions apply analogously to closing the mobile telephone 11 in the direction of arrow 23.

What is also explained by the descriptions is the reason why in an advantageous embodiment the spring 10 is under prestress in the stable end positions of the appliance parts 12 and 13. This ensures that the spring tension required for the two housing parts 12 and 13 to rotate independently does not first have to be created by the manually effected rotary part, resulting in long rotation paths or hard springs and reduced ease of use.

The force-reversal point 24 can be located in any desired manner on the movement path 21 as a function of the intended purpose. If the purpose is to divide the maximum travel of the appliance parts 12 and 13 relative to each other into two equal components, the manually effected motion component is the same as the subsequent independent motion component. For the user there is no difference between opening and closing the appliance. One example here would be a movement path 90° along which the force-reversal point is reached after a manual motion of 45°, while the remaining 45° is covered independently.

If for reasons of convenience the desired goal is fast opening and closing of the appliance, in other words, the goal is for the user to provide only one opening pulse, then the force-reversal point 24 must be moved comparatively close to the stable end position of appliance parts 12 and 13 relative to each other, which position corresponds to the closed position for the mobile telephone 11. Only a short manual motion must be effected until the force-reversal point 24 has been traversed; the remaining opening motion is completed solely due to the applied spring tension. From the opposite perspective, this means that the motion component of the manually effected motion is correspondingly greater for the closing motion.

As a result, the way is also opened for the second embodiment of the invention shown in FIGS. 7 and 8.

FIG. 7 provides a view, analogous to that of FIG. 4, of the first base part 15 or bottom shell 12 of the mobile telephone in the closed position. Here again, the spring 17 is under prestress and, if the first anchor point 18 is defined as the fixed point, pulls the second anchor point 19 along the movement path 21 in the direction of the spring force F as far as the anchor point 19, as the rotary stop, running in the guide 20 allows. The direction of motion for opening is thus the direction of the arrow 23.

However, since the force-reversal point 24 does not lie along the movement path of the anchor point 19, and thus both end positions for appliance parts 12 and 13 are located on the same side of the straight line 25, the opening motion occurs in the direction of the arrow 23 completely automatically due to the spring tension.

The open position is shown in FIG. 8, as is revealed by the changed position of the second anchor point 19 as compared with FIG. 7. Closing of the appliance, on the other hand, is effected manually in the movement direction 22 along with the creation of spring tension.

In this embodiment of the invention, there is only one stable end position, in this case specifically the open position. As a result, mechanical locking of the appliance is useful and desirable in the closed position.

Following the description of the inventive principle based on FIGS. 1 through 8 where a tension spring in the form of a meander-type spring is used, it is obvious to a person skilled in the art that the inventive principle can also be utilized with a compression spring.

If one mirrors the spring 17 at the mirror axis 26, indicated by a dash-dotted line in FIG. 6 but for the sake of clarity not shown continuously, and defines the anchor point 18 again as the fixed point and moves the anchor point 19 within the guide 20 along the movement path 21, the distance is reduced between the end positions of the anchor point 19 relative to the anchor point 18, as a result of which an additional spring force is applied to the spring 7 now under compressive prestress until the force-reversal point 24 is reached. From this point on, the motion is now once again completed independently as the compressive load of spring 17 is released.

The second embodiment shown in FIGS. 7 and 8 can be equipped with a compression spring analogously.

A mechanism (10) for opening and closing an appliance, such as a mobile telephone (11) or personal digital assistant, that comprises at least one first and one second base part (15 and 16) that are mounted so as to move about a common rotation axis (D, d) relative to each other, and are able to be moved between first and second end positions, wherein the movement path of the base parts (15 and 16) between the two positions is traversed partially automatically by means of a spring tension exerted by at least one spring (17) and created at least partially manually, the spring (17) being affixed at one end to the first base part (15) and on the other end to the second base part (16), characterized in that the spring (17) freely spans the space between the anchor points (18 and 19).

The mechanism according to claim 1, characterized in that the spring (17) is under prestress at the end positions of the base parts (15 and 16) and extending over the movement path.

The mechanism according to claims 1 or 2, characterized in that one base part (15) has a cutout (21) that a rotary stop (19) of the other base part (16) engages solely to limit the maximum travel of the base parts (15 and 16) relative to each other, wherein the rotary stop (19) is preferably designed as a fastening means for the spring (17).

The mechanism according to one of claims 1 through 3, characterized in that the spring (17) is of an essentially C-shaped design.

The mechanism according to one of claims 1 through 3, characterized in that the spring (17) is designed as a meander-type spring.

The mechanism according to one of the preceding claims, characterized in that the spring (17) is a stamped part composed of metal or plastic.

The mechanism according to one of the preceding claims, characterized in that the rotation axis (D, d) is located within a circular arc, the center of which is the anchor point (18) of the spring (17) on the first base part (15), and the radius of which runs through the anchor point (19) of the spring (17) on the second base part (16).

The mechanism according to claims 2 and 7, characterized in that the spring (17) is under tensile load.

The mechanism according to one of the preceding claims, characterized in that the rotation axis (D, d) is located outside a circular arc, the center of which is the anchor point (18) of the spring (17) on the first base part (15), and the radius of which runs through the anchor point (19) of the spring (17) on the second base part (16).

The mechanism according to claims 2 and 9, characterized in that the spring (17) has a compressive load as the prestress.

The mechanism according to claim 10, characterized in that the spring (17) is designed as a helical spring.

The mechanism according to one of the preceding claims, characterized in that the movement path corresponds to a partial circular path and increases the manually effected motion of the base parts (15 and 16) relative to each other up to a force-reversal point (24), such that after traversing the force-reversal point (24) the relative motion is completed independently with release of the spring tension, wherein the force-reversal point (24) corresponds to the intersection of a straight line (25) that runs through the anchor point (18) of the spring (17) on the first base part (15) and the rotation axis (d), and corresponds to a partial circular path.

The mechanism according to one of the preceding claims, characterized in that the movement path corresponds to a partial circular path of approximately 90°, and the two end positions are each set at an angle of approximately 45° relative to a straight line (25) that runs through the anchor point (18) of the spring (17) on the first base part (15) and the rotation axis (d).

The mechanism according to one of claims 1 through 11, characterized in that both end positions lie on the same side of a straight line (25) that runs through the anchor point (81) of the spring (17) on the first base part (15) and the rotation axis (d).

The mechanism according to one of the preceding claims, characterized in that the freely-spanned spring (17) is unguided between the anchor points (18 and 19).

1. A mechanism for opening and closing an appliance, such as a mobile telephone or personal digital assistant, that comprises at least one first and one second base part that are mounted so as to move about a common rotation axis relative to each other, and are able to be moved between first and second end positions, the movement path of the base parts between the two positions being traversed partially automatically by means of spring tension exerted by at least one spring and created at least partially manually, the spring being affixed at one end to the first base part and at the other end to the second base part wherein only one spring stamped out of metal or plastic is provided.

2. The mechanism according to claim 1 wherein the spring is under prestress at the end positions of the base parts and extending over the movement path.

3. The mechanism according to claim 1 wherein one base part has a cutout that a rotary stop of the other base part engages solely to limit the maximum travel of the base parts relative to each other, wherein the rotary stop is preferably designed as a fastening means for the spring.

4. The mechanism according to claim 1 wherein the spring is essentially C-shaped.

5. The mechanism according to claim 1 wherein the spring is a meander-type spring.

6. The mechanism according to claim 1 wherein the rotation axis is located within a circular arc having a center that the anchor point of the spring on the first base part and a radius that runs through the anchor point of the spring on the second base part.

7. The mechanism according to claim 2 wherein the spring is under tensile load.

8. The mechanism according to claim 1 wherein the rotation axis is located outside a circular arc having a center that is the anchor point of the spring on the first base part and a radius that runs through the anchor point of the spring on the second base part.

9. The mechanism according to claim 2 wherein the spring has a compressive load as the prestress.

10. The mechanism according to claim 9 wherein the spring is designed as a helical spring.

11. The mechanism according to claim 1 wherein the movement path corresponds to a partial circular path and increases the manually effected motion of the base parts relative to each other up to a force-reversal point, such that after traversing the force-reversal point the relative motion is completed independently with release of the spring tension, the force-reversal point corresponding to the intersection of a straight line that runs through the anchor point of the spring on the first base part and the rotation axis, and being a partial circular path.

12. The mechanism according to claim 1 wherein the movement path corresponds to a partial circular path of approximately 90°, and the two end positions are each set at an angle of approximately 45° relative to a straight line that runs through the anchor point of the spring on the first base part and the rotation axis.

13. The mechanism according to claim 1 wherein both end positions lie on the same side of a straight line that runs through the anchor point of the spring on the first base part and the rotation axis.

14. The mechanism according to claim 13 wherein the base parts are mechanically lockable to each other.

15. The mechanism according to one of the preceding claims wherein the freely spanned spring is unguided between the anchor points.
